(19) United States
(12) Patent Application Publication
(10) Pub. No.: US 2012/0018086 A1
(43) Pub. Date: Jan. 26, 2012

(54) METHOD FOR FABRICATING COMPOSITE MATERIAL FOR IN-MOLD DECORATION

(76) Inventor: Ching-Tu WANG, Taoyuan County (TW)

(21) Appl. No.: 12/873,490

(22) Filed: Sep. 1, 2010

(30) Foreign Application Priority Data
Jul. 21, 2010 (TW) 099123908

(51) Int. Cl. B29C 47/02

(52) U.S. Cl. 156/244.27

(57) ABSTRACT

A method for fabricating a composite material for in-mold decoration is to fabricate a composite material comprising a biomaterial layer and a protective layer adhering to the biomaterial layer. The method comprises the steps of: providing the biomaterial layer which is transferred in a predetermined transport path; hot-extruding the fused protective layer, wherein the hot-extruded protective layer is combined with the biomaterial layer in the transport path; and solidify and adhering the hot-extruded protective layer to the biomaterial layer to form the composite material. According to the method of the present invention, the composite material is formed via combining the protective layer with the biomaterial layer in a fused state, and via solidify and adhering the hot-extruded protective layer to the biomaterial layer, so as to reduce the bubbles between the protective layer and the biomaterial layer.

### FIELD OF THE INVENTION

The present invention relates to a method for fabricating a composite material for in-mode decoration, particularly to a method using a hot-extrusion technology to integrate a protective layer and a biomaterial layer.

### BACKGROUND OF THE INVENTION

In addition to achieving the requirement of superior functional quality, the manufacturers also usually promote the grade and price of the product via improving the surface, touch and recognizability by appearance and esthetic designs. The common industrial products, such as mobile phones or notebook computers, usually have a plastic casing. The casing is normally covered with a coating having color and gloss distinct from a plastic material. However, the casing still has a tactile feeling of plastic. Further, the coating will be gradually worn away after long-term usage with the plastic material finally outcropping. In general, the traditional coated plastic casing has inferior appearance and touch.

Therefore, some conventional technologies integrate a biomaterial with a metallic material to improve the appearance and touch of a product. For example, a Taiwan patent disclosed a “Composite Structure Used in Casing”, which comprises a surface layer and a bottom layer, wherein figures or patterns are directly printed on the surface layer with a digital injection print technology or a digital transfer-print technology, and wherein the surface layer is made of an arbitrary material and the bottom layer is made of a metallic sheet, and wherein an adhesive is used to integrate the surface layer and the bottom layer, whereby the surface layer may have various patterns and touches to implement various designs and satisfy requirements of different products, and whereby the value of the product is promoted. In the prior art, patterns or figures are printed on the surface layer with a digital injection print technology or a digital transfer-print technology, and an adhesive is used to integrate the surface layer with the bottom layer. As mentioned above, the bottom layer is made of a metallic material, and the surface layer is made of an arbitrary layer, such as a wood film, a leather film or a fabric.

In order to coat a biomaterial layer on a plastic or metallic casing, a biomaterial is provided firstly; the biomaterial is then fabricated to match the dimensions of the casing. Refer to FIG. 1 for a conventional technology, wherein an adhesive layer is coated on a base layer 3, and a biomaterial layer 1 is stuck to the adhesive layer 2 to conform to the casing. For example, a plurality of bamboo sheets is stuck to the adhesive layer 2 to form an integral biomaterial layer 1 having dimensions fitting the casing. Next, a protective layer 4 is stuck to the biomaterial layer 1 to secure and protect the biomaterial layer 1 and improve the color, gloss and smoothness of the biomaterial layer 1. Then, the base layer 3 and the adhesive layer 2 are removed, and the protective layer 4 takes charge of securing the biomaterial layer 1 from fracture.

In sticking the protective layer 4 to the biomaterial layer 1, poor applying usually generates bubbles 8 between the protective layer 4 and the biomaterial layer 1. Thus, the manufacturer has to spend a lot of manpower and time on removing the bubbles 8. However, the operation of removing the bubbles 8 may scrape off the protective layer 4 or the biomaterial layer 1. Therefore, the conventional technology of sticking the protective layer 4 to the biomaterial layer 1 wastes too much manpower and time and has poor productivity.

### SUMMARY OF THE INVENTION

The conventional technology in manufacture easily generates defects in sticking a protective layer to a biomaterial layer and wastes too much time and manpower on eliminating the defects. One objective of the present invention is to provide an improved method to solve the conventional problems by providing a hot-extruded protective layer and changing the fabrication process to reduce defects.

The present invention proposes a method for fabricating a composite material for in-mold decoration, which is used to fabricate a composite material comprising a biomaterial layer and a protective layer adhering to the biomaterial layer. The method of the present invention comprises the steps of: providing a biomaterial layer which is transferred in a predetermined transport path; hot-extruding a fused protective layer, wherein the hot-extruded protective layer is combined with the biomaterial layer in the transport path; and solidifying and adhering the hot-extruded protective layer to the biomaterial layer to form the composite material.

Via the abovementioned ways, the protective layer is applied on the biomaterial layer in a fused state, and then solidifies and adheres to the biomaterial layer to form a composite material, whereby are reduced the bubbles between the protective layer and the biomaterial layer.

### BRIEF DESCRIPTION OF THE DRAWINGS

FIG. 1 shows a conventional technology for fixing the biomaterial layer; and

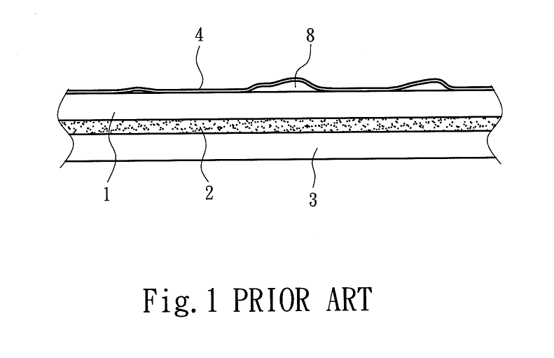

FIG. 2 is a schematic view showing a method for fabricating a composite material for in-mold decoration according to one embodiment of the present invention.

### DETAILED DESCRIPTION OF THE PREFERRED EMBODIMENTS

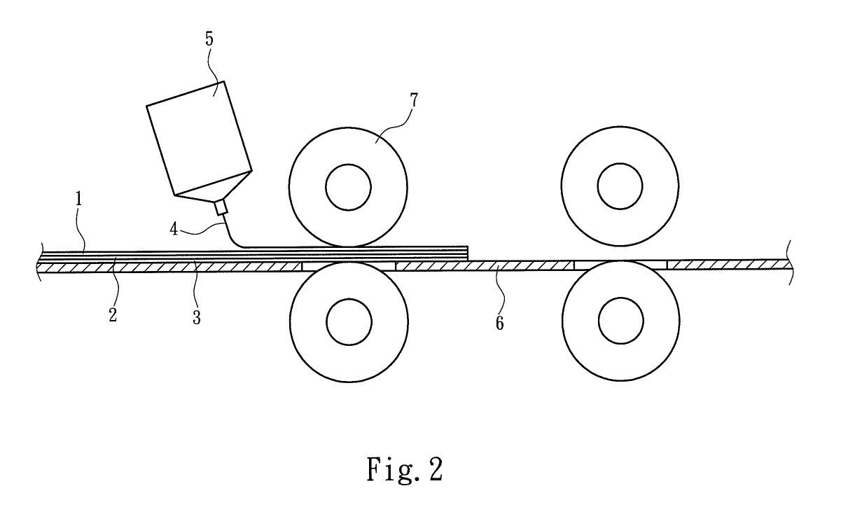

Refer to FIG. 2 for a method for fabricating a composite material for in-mold decoration according to one embodiment of the present invention. The method of the present invention is to fabricate a composite material for in-mold decoration. The composite material comprises a biomaterial layer 1 and a protective layer 4 adhering to the biomaterial layer 1. The biomaterial layer 1 is made of at least one of materials of bamboo films, wood films, leather films and leaves. The method of the present invention comprises at least the following steps of a) providing a biomaterial layer 1; b) hot-extruding a fused protective layer 4; and c) solidifying and adhering the hot-extruded protective layer 4 to the biomaterial layer 1. The biomaterial layer 1 is transferred in a predetermined transport path. For example, the biomaterial layer 1 is transferred by a conveying device 6, as shown in FIG. 2. In the step a), the biomaterial layer 1 adheres to one side of an adhesive layer 2, and another side of the adhesive layer 2 adheres to a fixing layer 3. The adhesive layer 2 and the fixing layer 3 are used to secure the biomaterial layer 1 to prevent the biomaterial layer 1 from loosening or fracturing. In the step b), the protective layer 4 is hot-extruded in a fused state by a hot-extrusion mechanism 5 to form a film. The protective layer 4 is made of at least one of materials of PET (polyethylene terephthalate), PEN (polyethylene naphthalate), PETG (polyethylene glycol-co-cyclohexane-1,4 dimethanol terephthalate), TPU (thermoplastic polyurethane), PU (polyurethane), PP (polypropylene), PC (polycarbonate), APET (amorphous polyethylene terephthalate), PVC (polyvinyl chloride), MS (methly-methacrylate-styrene), ABS (acrylonitrile-butadine-styrene), PS (polystyrene), POM (poly oxy methylene), and Nylon. The hot-extruded protective layer 4 is combined with the biomaterial layer 1 in the transport path. In the step c), the hot-extruded protective layer 4 solidifies and adheres to the biomaterial layer 1 to form the composite material 1. The protective layer 4 is directly combined with the biomaterial layer 1 in a fused state, so as to reduce the bubbles between the protective layer 4 and the composite material 1. In a preferred embodiment, referring to FIG. 2, after the combination of the hot-extruded protective layer 4 and the biomaterial layer 1, at least one roller mechanism 7 compresses the hot-extruded protective layer 4 and the biomaterial layer 1 to force the protective layer 4 to be uniformly distributed on the biomaterial layer 1. The roller mechanism 7 may have a temperature lower than the condensation point of the protective layer 4, so that the protective layer 4 will rapidly and completely solidify on the biomaterial layer 1 after rolling. The biomaterial layer 1 and the protective layer 4 coated on the biomaterial layer 1 are integrated to form the composite material after rolling. As the protective layer 4 can fix the biomaterial layer 1 securely, the adhesive layer 2 and the fixing layer 3 can be removed from the other side of the biomaterial layer 1. Thus is formed the composite material that can be used as an in-mold decorating process. Alternatively, the adhesive layer 2 and the fixing layer 3 are preserved to buffer the pressure and temperature of the succeeding injection-molding process or to combine with another material.

Via the method of the present invention, the composite material is formed via combining the protective layer 4 with the biomaterial layer 1 in a fused state, so as to reduce the bubbles and promote the productivity. Thus is saved the labor and time for checking and removing the defects. As the method of the present invention can be undertaken automatically with the conveying device 6, hot-extrusion mechanism 5 and roller mechanism 7, the manpower and cost for fabricating the composite material is further reduced.

The embodiments described above are only to exemplify the present invention but not to limit the scope of the present invention. Any equivalent modification or variation according to the spirit of the present invention is to be also included within the scope of the present invention, which is based on the claims stated below.

In conclusion, the present invention has improvements over the conventional technologies and satisfies the conditions for a patent—utility, novelty and non-obviousness. Thus, the Inventor files the application for a patent. It will be appreciated if the patent is approved fast.

What is claimed is:

1. A method for fabricating a composite material for in-mode decoration, which is used to provide a composite material comprising a biomaterial layer and a protective layer adhering to the biomaterial layer, the method comprising the steps of
providing the biomaterial layer which is transferred in a predetermined transport path;
hot-extruding the fused protective layer, wherein the hot-extruded protective layer is combined with the biomaterial layer in the transport path; and
solidifying and adhering the hot-extruded protective layer to the biomaterial layer to form the composite material.

2. The method for fabricating a composite material for in-mold decoration according to claim 1, wherein the biomaterial layer adheres to one side of an adhesive layer, and a fixing layer adheres to another side of the adhesive layer.

3. The method for fabricating a composite material for in-mold decoration according to claim 2, wherein after combination of the hot-extruded protective layer and the biomaterial layer, at least one roller mechanism compresses the hot-extruded protective layer and the biomaterial layer to force the protective layer to be uniformly distributed on the biomaterial layer.

4. The method for fabricating a composite material for in-mold decoration according to claim 3, wherein the roller mechanism has a temperature lower than a condensation point of the protective layer.

5. The method for fabricating a composite material for in-mold decoration according to claim 1, wherein the protective layer is made of a material selected from a group consisting of PET (polyethylene terephthalate), PEN (polyethylene naphthalate), PETG (polyethylene glycol-co-cyclohexane-1,4 dimethanol terephthalate), TPU (thermoplastic polyurethane), PU (polyurethane), PP (polypropylene), PC (polycarbonate), APET (amorphous polyethylene terephthalate), PVC (polyvinyl chloride), MS (methly-methacrylate-styrene), ABS (acrylonitrile-butadine-styrene), PS (polystyrene), POM (poly oxy methylene), and Nylon.

6. The method for fabricating a composite material for in-mold decoration according to claim 1, wherein the biomaterial layer is made of a material selected from a group consisting of bamboo films, wood films, leather films and leaves.

7. The method for fabricating a composite material for in-mold decoration according to claim 1, wherein after combination of the hot-extruded protective layer and the biomaterial layer, at least one roller mechanism compresses the hot-extruded protective layer and the biomaterial layer to force the protective layer to be uniformly distributed on the biomaterial layer.

8. The method for fabricating a composite material for in-mold decoration according to claim 7, wherein the roller mechanism has a temperature lower than a condensation point of the protective layer.
